(19) United States
(12) Patent Application Publication
(10) Pub. No.: US 2025/0150852 A1
(43) Pub. Date: May 8, 2025

(54) RRM RELAXATION ENHANCEMENT IN EDRX MODE

(71) Applicant: APPLE INC., Cupertino, CA (US)

(72) Inventors: Jie Cui, San Jose, CA (US); Hong He, San Jose, CA (US); Yang Tang, San Jose, CA (US); Qiming Li, Beijing (CN); Manasa Raghavan, Sunnyvale, CA (US); Yuanye Wang, San Jose, CA (US); Xiang Chen, Campbell, CA (US); Dawei Zhang, Saratoga, CA (US); Qunfeng He, San Diego, CA (US)

(21) Appl. No.: 18/837,415

(22) PCT Filed: Feb. 11, 2022
(86) PCT No.: PCT/CN2022/076060

§ 371 Date: Aug. 9, 2024

(51) Int. Cl. H04W 24/02; H04W 68/02; H04W 76/28

(52) U.S. Cl. CPC H04W 24/02; H04W 68/02; H04W 76/28

(57) ABSTRACT

A user equipment (UE) configures radio resource management (RRM) relaxation in extended discontinuous reception (eDRX) in cases with or without a paging transmission window (PTW). The UE determines whether an eDRX cycle is configured as being greater or less than 10.24 seconds; determine whether the UE has met legacy RRM relaxation criteria for a relaxation scaling factor k; and configures RRM relaxation timing based on use of a paging transmission window (PTW) and the relaxation scaling factor k.

### TECHNICAL FIELD

This application relates generally to wireless communication systems, including RRM relaxation based on eDRX with and without PTW.

### BACKGROUND INFORMATION

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

A UE may connect to either one or both of a 5G NR RAT and LTE RAT. The UE may support standalone carrier aggregation (CA) on LTE, CA on NR (NR-CA), or a variety of dual-connectivity (DC) functionalities in which a plurality of component carriers (CCs) are combined across LTE and NR. Each CC may represent a channel that facilitates communication between the UE and the network over a particular frequency band. A plurality of CCs may correspond to the same frequency band, each CC may correspond to a different band, or a combination of CCs across the same frequency band and different frequency bands may be used.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram of an example architecture of a wireless communication system, according to embodiments disclosed herein.

FIG. 2 is a set of timing diagrams in accordance with one embodiment.

FIG. 3 is a set of timing diagrams in accordance with one embodiment.

FIG. 4 is a set of timing diagrams in accordance with one embodiment.

FIG. 5 is a set of timing diagrams in accordance with one embodiment.

FIG. 6 is a set of timing diagrams in accordance with one embodiment.

FIG. 7 is a set of timing diagrams in accordance with one embodiment.

FIG. 8 is a set of timing diagrams in accordance with one embodiment.

FIG. 9 is a set of timing diagrams in accordance with one embodiment.

FIG. 10 is a set of timing diagrams in accordance with one embodiment.

FIG. 11 is a flow diagram in accordance with one embodiment.

FIG. 12 is a block diagram of a system for performing signaling between a wireless device and a network device, according to embodiments disclosed herein.

### DETAILED DESCRIPTION OF EMBODIMENTS

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

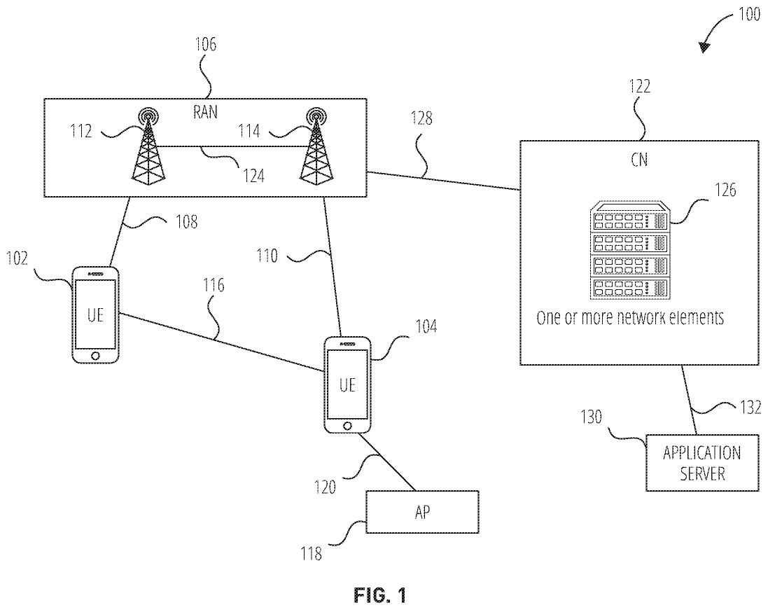

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 1202.11 protocol, wherein the AP 118 may comprise a Wi-Fi® router. In this example, the AP 118 may be connected to another network (for example, the Internet) without going through a CN 122.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 124. In embodiments where the wireless communication system 100 is an LTE system (e.g., when the CN 122 is an EPC), the interface 124 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 122 is a 5GC), the interface 124 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 122).

The RAN 106 is shown to be communicatively coupled to the CN 122. The CN 122 may comprise one or more network elements 126, which are configured to offer various data and telecommunications services to customers/subscribers (e.g., users of UE 102 and UE 104) who are connected to the CN 122 via the RAN 106. The components of the CN 122 may be implemented in one physical device or separate physical devices including components to read and execute instructions from a machine-readable or computer-readable medium (e.g., a non-transitory machine-readable storage medium).

In embodiments, the CN 122 may be an EPC, and the RAN 106 may be connected with the CN 122 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 122 may be a 5GC, and the RAN 106 may be connected with the CN 122 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 122 (e.g., packet switched data services). The application server 130 can also be configured to support one or more communication services (e.g., VOIP sessions, group communication sessions, etc.) for the UE 102 and UE 104 via the CN 122. The application server 130 may communicate with the CN 122 through an IP communications interface 132.

A UE configured for 3GPP wireless communications is typically active for a paging cycle every 1.28 seconds(s). In contrast, a UE leveraging extended discontinuous reception (eDRX) is active for a paging cycle every 10.24 seconds, which saves power when the UE is connected to the network and communicating or idle. This eDRX mode (or simply, eDRX) also allows the UE to tell the network that it would like to skip some predetermined number of these 10.24 second cycles, extending paging intervals up to 10485.76 seconds. Thus, eDRX facilitates reduced power consumption for devices that are awake and connected/idle in the network.

In a RAN4 #101-bis-e meeting, a radio resource management (RRM) relaxation mechanism in eDRX mode was discussed. No consensus has been reached. A summary of the pertinent issues discussed is set forth as follows.

An issue 2-2-4 under discussion was to consider options on eDRX when eDRX is up to 10.24 seconds(s). In response, the following two options were proposed. According to a first option, Rel-16/17 relaxed measurement requirements could be applied with eDRX cycles up to 10.24 seconds, without any paging transmission window (PTW, which is relatively long, i.e., on the order of 20 or 30 seconds). According to a second option, the eDRX measurement could be decoupled with neighbor cell measurement relaxation, i.e., specify RRM neighbor cell measurement relaxations for DRX only.

An issue 2-2-5 under discussion was to consider of eDRX with PTW. In response, the following option was proposed. According to a first option, the maximum eDRX cycles with PTW up to which a UE is allowed to apply Rel-16/17 relaxed measurement requirements is X ms, where value of X is for future study.

Based on the previous agreements, when eDRX is up to 10.24 seconds, the PTW is not used for IDLE mode. When eDRX is greater than 10.24 seconds, the PTW is used for inactive mode. When inactive mode is used, eDRX can be configured up to 10.24 seconds, and therefore the PTW is not used for inactive mode.

The agreements for the legacy eDRX RRM measurement (without relaxation) are as follows. For both FR1 and FR2, when eDRX greater than 10.24 seconds is used at an NR reduced capability (RedCap) UE in IDLE mode, (a) the number of samples needed for N serv of serving cell measurement (measured in DRX cycles) must be contained in a single PTW length; (b) the number of samples needed for T_{measure,NR}/T_{evaluate,NR} of intra-freq or inter-freq cell measurement (measured in DRX cycles) must be contained in a single PTW length; and the number of samples needed for T_{detect,NR} of intra-freq or inter-freq cell measurement (measured in DRX cycles) could be split into different PTWs.

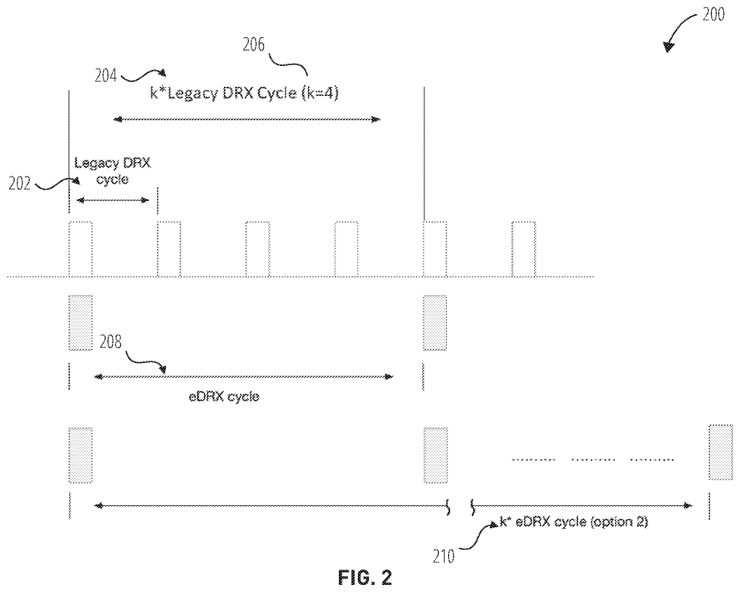

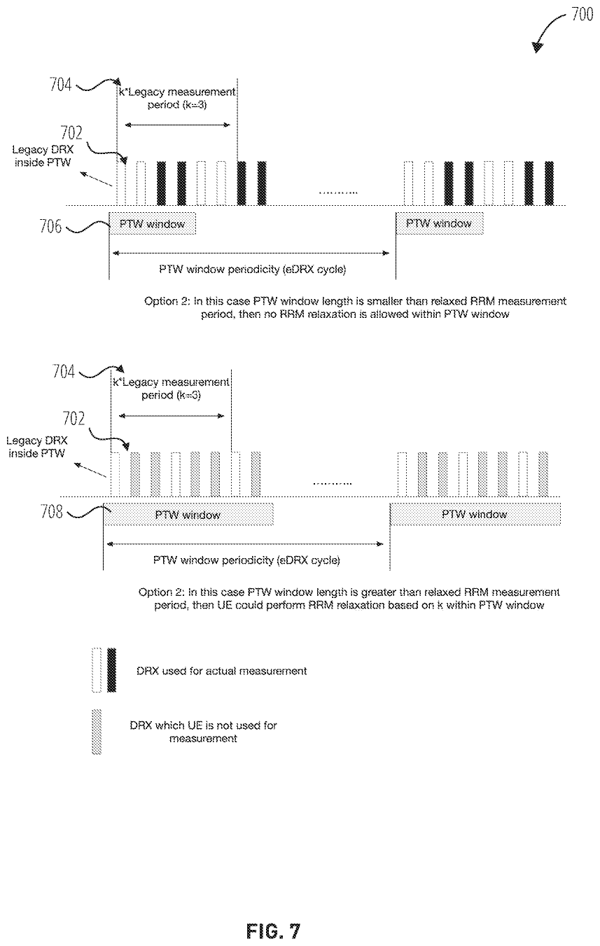

This disclosure, therefore, addresses several other issues such as, for example, how to determine the RRM relaxation based on eDRX without PTW (see, e.g., discussion with reference to FIG. 2-FIG. 5) and with PTW (see, e.g., discussion with reference to FIG. 7-FIG. 10).

Initially, it is noted that the parameter k is a relaxation scaling factor to scale the measurement interval between two samples, where the parameter k could be predefined in specifications or signaled by the network. For example, if two physical layer samples are needed for one cell measurement, then in the legacy case (i.e., without relaxation), two DRX cycles would be used to complete the measurements. But, in an example with the scaling factor k equal to three, the two DRX cycles would be scaled by a factor of three such that six DRX cycles would be used to complete the measurement.

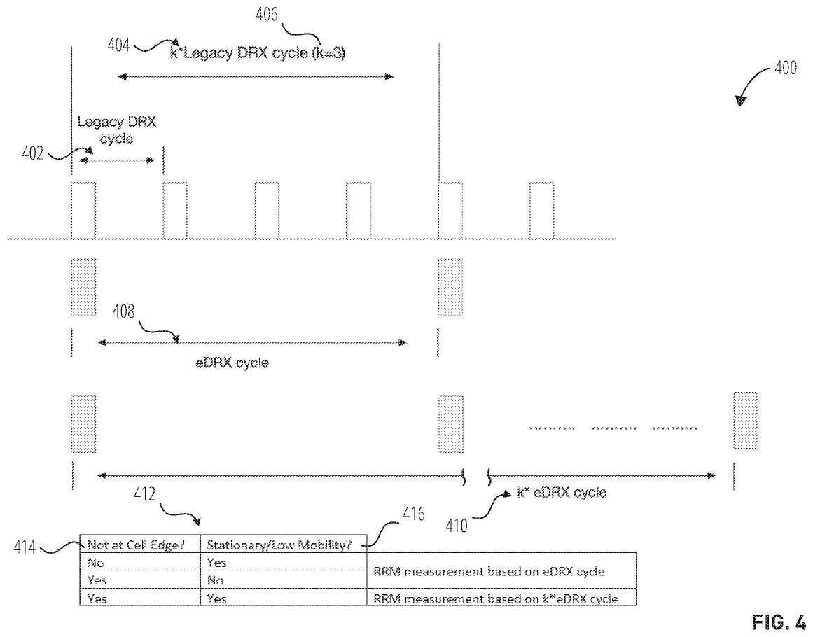

There are several options for when eDRX is configured up to 10.24 seconds, and the PTW is not used in IDLE and inactive mode. The following options apply when UE has met the legacy RRM relaxation criteria (see, e.g., 3GPP TS 38.133 sections 4.2.2.9 and 4.2.210 and criteria shown in table of FIG. 4) for legacy DRX in IDLE and Inactive mode) for the relaxation scaling factor, k (i.e., k is applied to legacy DRX based measurement).

To show the first two options, FIG. 2 includes a set of timing diagrams 200. Set of timing diagrams 200 includes a legacy DRX cycle 202, a k*DRX cycle 204 (in which a legacy RRM relaxation factor k 206 is equal to four), an eDRX cycle 208, and a fragmentary view of a k*eDRX cycle 210. Legacy RRM relaxation factor k 206, which may have values other than four, is shown applied to legacy DRX cycle 202 to form k*DRX cycle 204. Accordingly, FIG. 2 shows a first option in which is that the UE would follow eDRX cycle 208 for RRM measurement regardless of any legacy RRM relaxation factor, e.g., legacy RRM relaxation factor k 206. FIG. 2 also shows a second option in which the UE would apply legacy RRM relaxation factor k 206 on eDRX cycle 208, so that the UE implements RRM measurement based on k*eDRX cycle 210.

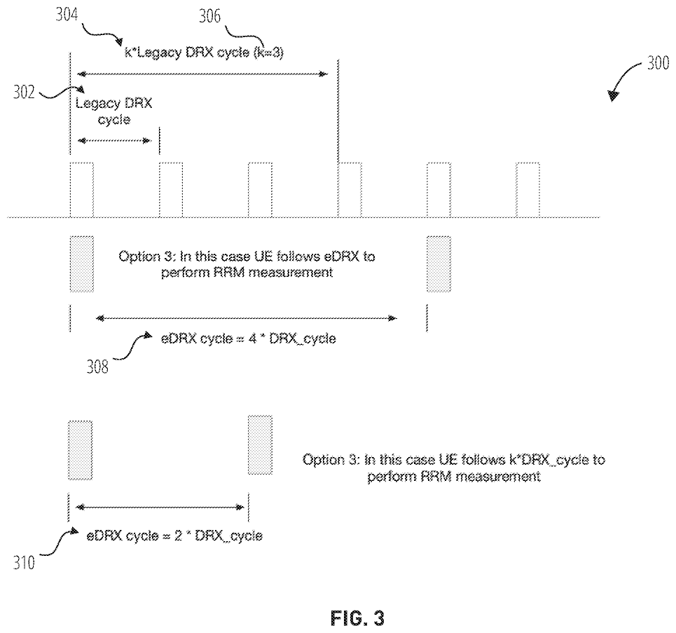

FIG. 3 shows a third option by way of an example set of timing diagrams 300. Set of timing diagrams 300 includes a legacy DRX cycle 302, a k*DRX cycle 304 (in which a legacy RRM relaxation factor k 306 is equal to three), a first eDRX cycle 308, a second eDRX cycle 310. Legacy RRM relaxation factor k 306, which may have values other than three, is shown applied to legacy DRX cycle 302 to form k*DRX cycle 304.

According to option three, the value of an eDRX cycle divided by an DRX cycle (i.e., a ratio of these values) is compared to the value of k. If (eDRX cycle)/(DRX cycle) is greater than or equal to k, then the UE implements its RRM measurement based on eDRX without relaxation scaling factor. And otherwise, if (eDRX cycle)/(DRX cycle) is less than k, then the UE implements its RRM measurement based on a k*DRX cycle. For instance, first eDRX cycle 308 divided by legacy DRX cycle 302 is equal to four, which is greater than legacy RRM relaxation factor k 306. Thus, the UE would follow the timing of first eDRX cycle 308 to perform RRM measurement. Conversely, second eDRX cycle 310 divided by legacy DRX cycle 302 is equal to two, which is less than legacy RRM relaxation factor k 306. Thus, the UE would follow the timing of k*DRX cycle 304 to perform RRM measurement.

FIG. 4 shows a fourth option by way of an example set of timing diagrams 400. Set of timing diagrams 400 includes a legacy DRX cycle 402, a k*DRX cycle 404 (in which a legacy RRM relaxation factor k 406 is equal to three), an eDRX cycle 408, and a k*eDRX cycle 410. Legacy RRM relaxation factor k 406, which may have values other than three, is shown applied to legacy DRX cycle 402 to form k*DRX cycle 404. Legacy RRM relaxation factor k 406 is also shown applied to eDRX cycle 408 to form k*eDRX cycle 410.

According to option four, a UE could artificially change criteria 412 for RRM relaxation for eDRX. For instance, if legacy RRM relaxation factor k 406 applies when UE has met one criterion (either not at cell edge criterion 414 or stationary/low mobility criterion 416), then that k factor would apply for eDRX based RRM when both criteria 414, 416 are met.

“Not at cell edge” 414 means the serving cell RSRP measurement result is above a threshold. If UE measured RSRP is above this threshold, then UE determine this criterion is met.

“Low mobility” 416 means the serving cell RSRP variation during a certain period is below a threshold. If the variation of the UE measured RSRPs during a certain period is below a threshold, then the UE determine this criterion is met.

When both are met, the UE implements RRM measurement based on k*eDRX cycle 410. Otherwise, if none or only one criterion is met, then the UE implements RRM measurement based on eDRX cycle 408.

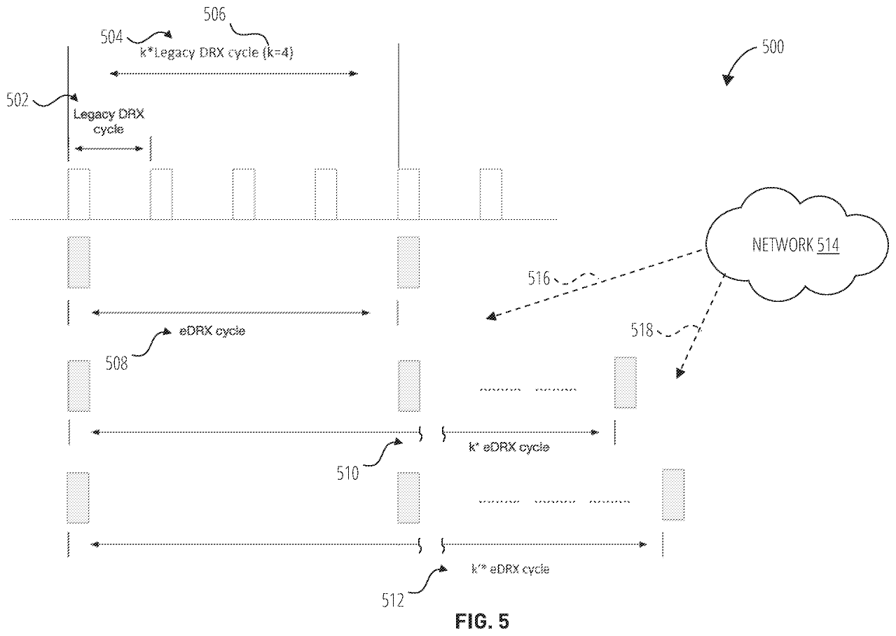

FIG. 5 shows a fourth option by way of an example set of timing diagrams 500. Set of timing diagrams 500 includes a legacy DRX cycle 502, a k*DRX cycle 504 (in which a legacy RRM relaxation factor k 506 is equal to four), an eDRX cycle 508, a k*eDRX cycle 510, and a k′*eDRX cycle 512. Legacy RRM relaxation factor k 506, which may have values other than four, is shown applied to legacy DRX cycle 502 to form k*DRX cycle 504. Another factor, k′, different from legacy RRM relaxation factor k 506, is shown applied to eDRX cycle 508 to form k′*eDRX cycle 512.

According to option five, in one embodiment, a network 514 indicates whether the RRM measurement based on eDRX could be relaxed. For instance, network 514 indicates 516 to relax eDRX cycle 508, and legacy RRM relaxation factor k 506 is applied on eDRX cycle 508 to form k*eDRX cycle 510. In another embodiment, network 514 indicates 518 an individual relaxation factor k′ applied to eDRX cycle 508 so that the UE implements RRM measurement based on k′*eDRX cycle 512. Indication 516 or 518 could be carried on system information, broadcasting channels, or dedicated downlink channels.

To determine the RRM relaxation based on eDRX with PTW, there are addition issues to consider depending on whether a relaxation scaling factor, k, is employed such that k*legacy measurement period is greater or less than the PTW. For instance, if k*legacy measurement period is greater than the PTW, then the UE behavior/assumption should be specified, e.g., the UE behavior could differentiate among different use cases such as between measurement/evaluation and cell detection. And if k*legacy measurement period is less than the PTW, then the UE behavior/assumption should also be specified.

There are several options for when eDRX is configured as greater than 10.24 seconds, and the PTW is used in IDLE mode. The following options apply when UE has met the legacy RRM relaxation criteria (criteria defined for legacy DRX in IDLE mode) for the relaxation scaling factor, k (i.e., k is applied to legacy DRX based measurement). As discussed previously, k could be predefined in specifications or signaled by the network.

FIG. 7 shows a first option by way of a set of timing diagrams 700. Set of timing diagrams 200 includes a legacy DRX cycle 602, a k*DRX cycle 604 (in which a legacy RRM relaxation factor k 606 is equal to three), and a PTW periodicity (eDRX cycle) 608. In this example, RRM measurement period is 2*legacy DRX cycle 602.

According to option one, a UE would retain PTW periodicity (eDRX cycle) 608 for RRM measurement regardless of legacy RRM relaxation factor k 606. The measurement interval/periodicity inside PTW 610 is retained as well, e.g., no relaxation is allowed when PTW is used.

FIG. 7 shows a second option by way of a set of timing diagrams 700. In this example, a legacy measurement period is 2*legacy DRX cycle 702.

As shown in the upper portion of FIG. 7, if a relaxed measurement period 704 (legacy measurement period*k) is greater than a length of PTW 706, no relaxation is allowed within each PTW window. Otherwise, as shown in the bottom portion of FIG. 7, if relaxed measurement period 704 (legacy measurement period*k) is less than or equal to a length of PTW 708, the UE perform RRM measurement based on k*legacy DRX cycle 702 within each PTW.

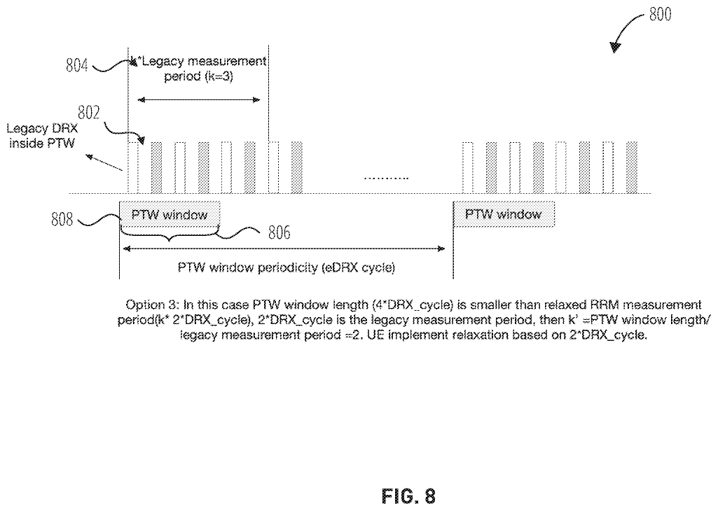

FIG. 8 shows a third option by way of another example set of timing diagrams 800. In this example, a legacy measurement period is 2*legacy DRX cycle 802. If a relaxed measurement period 804 (legacy measurement period*k) is greater than a length 806 of a PTW 808, a UE employs k′ to perform RRM measurement relaxation based on k′*legacy measurement period, where k′ equals length 806 (in units of legacy DRX cycle 802) divided by the legacy measurement period (in units of legacy DRX cycle 802). Otherwise, if relaxed measurement period (legacy measurement period*k) is less than or equal to a PTW length, the UE performs RRM measurement based on k* legacy DRX cycle 802 within each PTW.

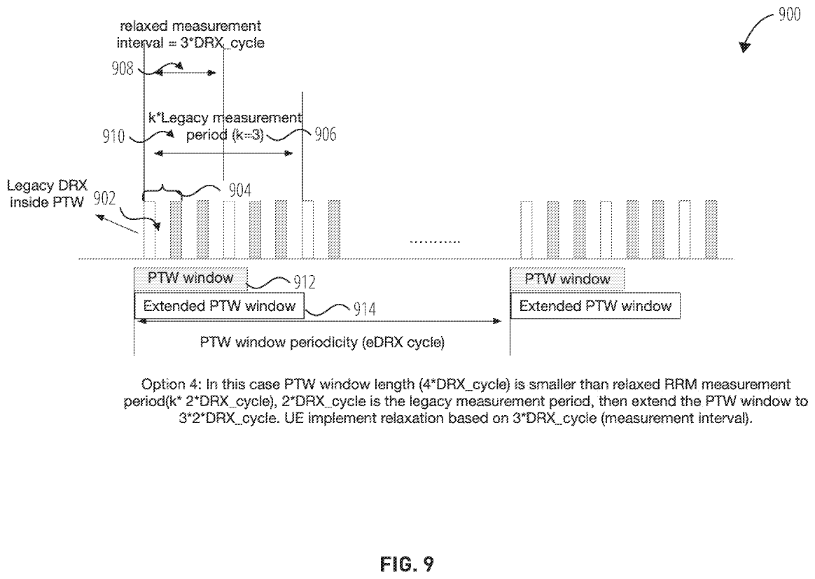

FIG. 9 shows a fourth option by way of another example set of timing diagrams 900. In this example, a UE needs two samples to complete one measurement or complete one PHY filtering for a measurement. And the time interval between two samples is one legacy DRX cycle 902, so a total legacy measurement period 904 is 2*legacy DRX cycle 902. If a legacy RRM relaxation factor k 906 is used (k=3, in the example), this scales the time interval between two samples. That is, one measurement period still needs two samples, but a relaxed measurement interval 908 between such samples is scaled from one legacy DRX cycle 902 to k*1*legacy DRX cycle 902, i.e., 3*legacy DRX cycle 902. Then in total, a relaxed measurement period 910 would be “sample number”*“sample interval”, i.e., 2*3*legacy DRX cycle 902. But this relaxed measurement period 910 would exceed an existing PTW length 912. Accordingly, option four provides for an extended PTW length 914 to cover relaxed measurement period 910 (6* legacy DRX cycle 902).

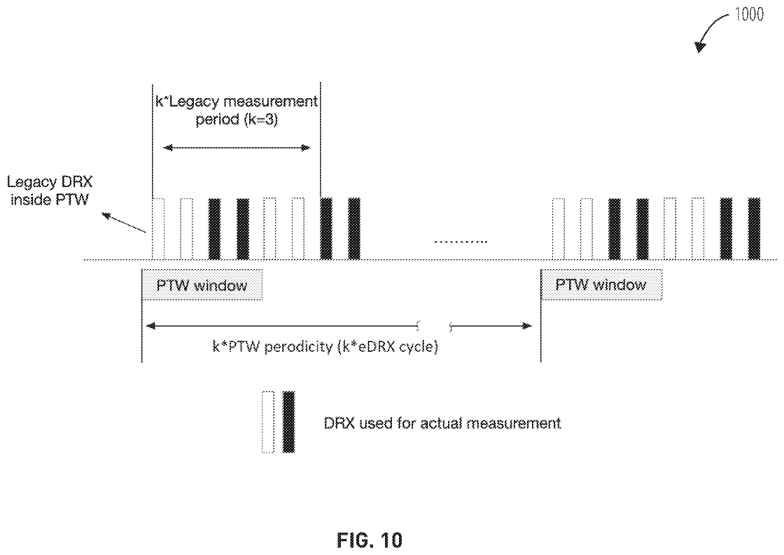

FIG. 10 shows a fifth option by way of another example set of timing diagrams 1000. In this example, a UE would apply legacy RRM relaxation factor k on the PTW periodicity (i.e., eDRX cycle), and the UE implements to extend the PTW periodicity based on k*eDRX cycle. But within each PTW, the RRM measurement is still based on 1*DRX cycle.

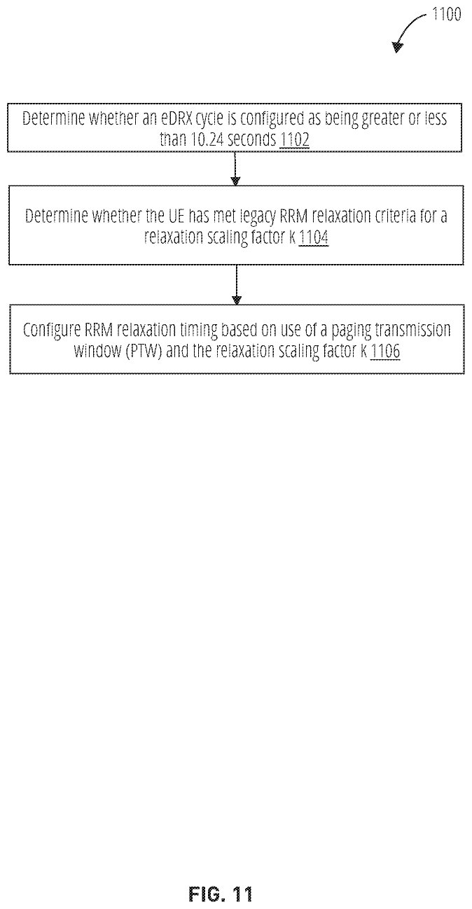

FIG. 11 shows a flow diagram of a method 1100, performed by a user equipment (UE), for configuring radio resource management (RRM) relaxation in extended discontinuous reception (eDRX) mode.

In block 1102, method 1100 determines whether a eDRX cycle is configured as being greater or less than 10.24 seconds. The eDRX cycle information is configured in system information broadcasted by network. The determination in block 1102 may be made by checking a previous eDRX configuration setting stored in memory.

In block 1104, method 1100 determines whether the UE has met legacy RRM relaxation criteria for a relaxation scaling factor k. Examples of the criteria are provided in the table of FIG. 4. For instance, the legacy RRM relaxation criteria could be “Not at cell edge” and/or “low mobility,” as long as the UE can meet one of them the k relaxation factor could be used in legacy case. The RRM relaxation criteria are configured in system information broadcasted by network. The determination in block 1104 may be made by checking a previous eDRX configuration setting stored in memory.

In block 1106, method 1100 configures RRM relaxation timing based on use of a paging transmission window (PTW) and the relaxation scaling factor k. For example, if the eDRX cycle is less than or equal to 10.24 seconds and at least one criterion is satisfied, then the UE may configure RRM relaxation based on the techniques described previously with reference to FIG. 2-FIG. 5. Method 1100 may also include, in response to the eDRX cycle being less than or equal to 10.24 seconds and the PTW not being used in IDLE or Inactive mode, configuring the RRM relaxation timing to follow the eDRX cycle irrespective of the relaxation scaling factor k. Method 1100 may also include, in response to the eDRX cycle being less than or equal to 10.24 seconds and the PTW not being used in IDLE or Inactive mode, configuring the RRM relaxation timing by applying the relaxation scaling factor k on the eDRX cycle to implement RRM measurement based on the relaxation scaling factor k applied to the eDRX cycle. Method 1100 may also include, in response to the eDRX cycle being less than or equal to 10.24 seconds and the PTW not being used in IDLE or Inactive mode, configuring the RRM relaxation timing based on a comparison of the relaxation scaling factor to a ratio between the eDRX cycle and a legacy DRX cycle. Method 1100 may also include, in response to the eDRX cycle being less than or equal to 10.24 seconds and the PTW not being used in IDLE or Inactive mode, determining multiple relaxation criteria are met, the criteria including the UE is not at cell edge and that it is stationary or low mobility, and implementing RRM measurement based on the relaxation scaling factor k applied to the eDRX cycle. Method 1100 may also include, in response to the eDRX cycle being less than or equal to 10.24 seconds and the PTW not being used in IDLE or Inactive mode, receiving from a network an indication to relax RRM measurement based on the relaxation scaling factor k or an individual scaling factor k′ applied to the eDRX cycle.

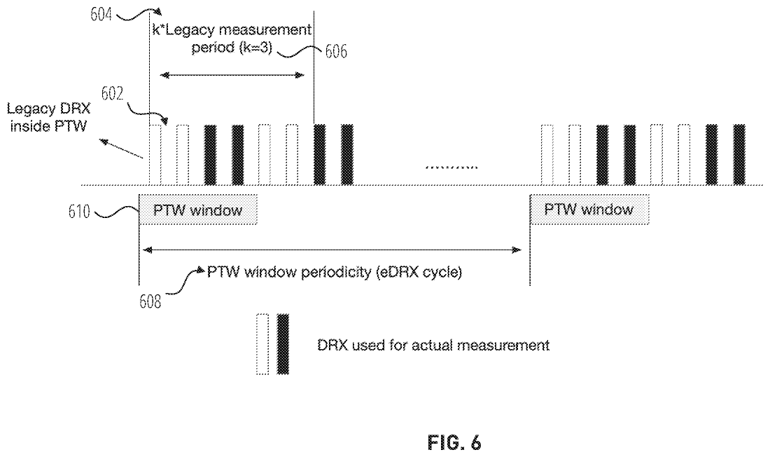

In contrast, if the eDRX cycle is greater than 10.24 seconds and at least one criterion is satisfied, then the UE may configure RRM relaxation based on the techniques described previously with reference to FIG. 6-FIG. 10. Method 1100 may also include, in response to the eDRX cycle being greater than 10.24 seconds and the PTW being used in IDLE mode, retaining PTW periodicity corresponding to the eDRX cycle for RRM measurement. Method 1100 may also include, in response to the eDRX cycle being greater than 10.24 seconds and the PTW being used in IDLE mode, determining whether a relaxed measurement period corresponding to the relaxation scaling factor k applied to a legacy measurement period is greater than a length of the PTW. Method 1100 may also include in which, in response to the relaxed measurement period being greater than the length of the PTW, configuring no relaxation within each PTW. Method 1100 may also include in which, in response to the relaxed measurement period being greater than the length of the PTW, employing another scaling factor k′ to perform RRM measurement relaxation, in which k′is equal to the length of the PTW in units of a legacy DRX cycle divided by the legacy measurement period in units of the legacy DRX cycle. Method 1100 may also include in which, in response to the relaxed measurement period being greater than the length of the PTW, extending the PTW to the relaxation scaling factor k*the legacy measurement period. Method 1100 may also include, in response to the eDRX cycle being greater than 10.24 seconds and the PTW being used in IDLE mode, applying the relaxation scaling factor k to PTW periodicity corresponding to the eDRX cycle, and implementing RRM measurement within each PTW based on one legacy DRX cycle as a measurement interval.

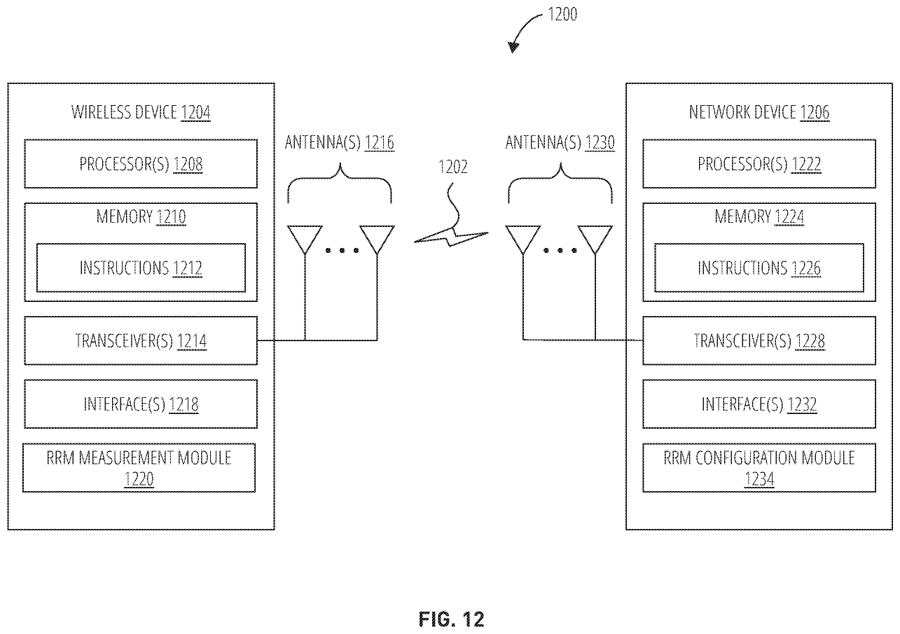

FIG. 12 illustrates a system 1200 for performing signaling 1202 between a wireless device 1204 and a network device 1206, according to embodiments disclosed herein. System 1200 may be a portion of a wireless communications system as herein described. Wireless device 1204 may be, for example, a UE of a wireless communication system. Network device 1206 may be, for example, a base station (e.g., an eNB or a gNB) of a wireless communication system.

Wireless device 1204 may include one or more processor(s) 1208. Processor(s) 1208 may execute instructions such that various operations of wireless device 1204 are performed, as described herein. Processor(s) 1208 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

Wireless device 1204 may include a memory 1210. Memory 1210 may be a non-transitory computer-readable storage medium that stores instructions 1212 (which may include, for example, the instructions being executed by processor(s) 1208). Instructions 1212 may also be referred to as program code or a computer program. Memory 1210 may also store data used by, and results computed by, processor(s) 1208.

Wireless device 1204 may include one or more transceiver(s) 1214 that may include radio frequency (RF) transmitter and/or receiver circuitry that use antenna(s) 1216 of wireless device 1204 to facilitate signaling (e.g., signaling 1202) to and/or from wireless device 1204 with other devices (e.g., network device 1206) according to corresponding RATs.

Wireless device 1204 may include one or more antenna(s) 1216 (e.g., one, two, four, or more). For embodiments with multiple antenna(s) 1216, wireless device 1204 may leverage the spatial diversity of such multiple antenna(s) 1216 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by wireless device 1204 may be accomplished according to precoding (or digital beamforming) that is applied at wireless device 1204 that multiplexes the data streams across antenna(s) 1216 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, wireless device 1204 may implement analog beamforming techniques, whereby phases of the signals sent by antenna(s) 1216 are relatively adjusted such that the (joint) transmission of antenna(s) 1216 can be directed (this is sometimes referred to as beam steering).

Wireless device 1204 may include one or more interface(s) 1218. Interface(s) 1218 may be used to provide input to or output from wireless device 1204. For example, a wireless device 1204 that is a UE may include interface(s) 1218 such as microphones, speakers, a touchscreen, buttons, and the like in order to allow for input and/or output to the UE by a user of the UE. Other interfaces of such a UE may be made up of made up of transmitters, receivers, and other circuitry (e.g., other than transceiver(s) 1214/antenna(s) 1216 already described) that allow for communication between the UE and other devices and may operate according to known protocols (e.g., Wi-Fi®, Bluetooth®, and the like).

Wireless device 1204 may include an RRM measurement module 1220. RRM measurement module 1220 may be implemented via hardware, software, or combinations thereof. For example, RRM measurement module 1220 may be implemented as a processor, circuit, and/or instructions 1212 stored in memory 1210 and executed by processor(s) 1208. In some examples, RRM measurement module 1220 may be integrated within processor(s) 1208 and/or transceiver(s) 1214. For example, RRM measurement module 1220 may be implemented by a combination of software components (e.g., executed by a DSP or a general processor) and hardware components (e.g., logic gates and circuitry) within processor(s) 1208 or transceiver(s) 1214.

RRM measurement module 1220 may be used for various aspects of the present disclosure, for example, aspects of FIG. 1-FIG. 11. In some embodiments, RRM measurement module 1220 is configured to facilitate capability exchange and configuration of RRM relaxation based on eDRX. Embodiments contemplated herein include an apparatus comprising means to perform one or more elements of method 1100 (FIG. 11). This apparatus may be, for example, an apparatus of a UE (such as a wireless device 1204 that is a UE, as described herein).

Embodiments contemplated herein include one or more non-transitory computer-readable media comprising instructions to cause an electronic device, upon execution of the instructions by one or more processors of the electronic device, to perform one or more elements of method 1100 (FIG. 11). This non-transitory computer-readable media may be, for example, a memory of a UE (such as a memory 1210 of a wireless device 1204 that is a UE, as described herein).

Embodiments contemplated herein include an apparatus comprising logic, modules, or circuitry to perform one or more elements of method 1100 (FIG. 11). This apparatus may be, for example, an apparatus of a UE (such as a wireless device 1204 that is a UE, as described herein).

Embodiments contemplated herein include an apparatus comprising: one or more processors and one or more computer-readable media comprising instructions that, when executed by the one or more processors, cause the one or more processors to perform one or more elements of method 1100 (FIG. 11). This apparatus may be, for example, an apparatus of a UE (such as a wireless device 1204 that is a UE, as described herein).

Embodiments contemplated herein include a computer program or computer program product comprising instructions, wherein execution of the program by a processor is to cause the processor to carry out one or more elements of method 1100 (FIG. 11). The processor may be a processor of a UE (such as a processor(s) 1208 of a wireless device 1204 that is a UE, as described herein). These instructions may be, for example, located in the processor and/or on a memory of the UE (such as a memory 1210 of a wireless device 1204 that is a UE, as described herein).

Network device 1206 may include one or more processor(s) 1222. processor(s) 1222 may execute instructions such that various operations of network device 1206 are performed, as described herein. Processor(s) 1222 may include one or more baseband processors implemented using, for example, a CPU, a DSP, an ASIC, a controller, an FPGA device, another hardware device, a firmware device, or any combination thereof configured to perform the operations described herein.

Network device 1206 may include a memory 1224. Memory 1224 may be a non-transitory computer-readable storage medium that stores instructions 1226 (which may include, for example, the instructions being executed by processor(s) 1222). Instructions 1226 may also be referred to as program code or a computer program. Memory 1224 may also store data used by, and results computed by, processor(s) 1222.

Network device 1206 may include one or more transceiver(s) 1228 that may include RF transmitter and/or receiver circuitry that use antenna(s) 1230 of network device 1206 to facilitate signaling (e.g., signaling 1202) to and/or from network device 1206 with other devices (e.g., wireless device 1204) according to corresponding RATs.

Network device 1206 may include one or more antenna(s) 1230 (e.g., one, two, four, or more). In embodiments having multiple antenna(s) 1230, network device 1206 may perform MIMO, digital beamforming, analog beamforming, beam steering, etc., as has been described.

Network device 1206 may include one or more interface(s) 1232. Interface(s) 1232 may be used to provide input to or output from network device 1206. For example, a network device 1206 that is a base station may include interface(s) 1232 made up of transmitters, receivers, and other circuitry (e.g., other than transceiver(s) 1228/antenna(s) 1230 already described) that enables the base station to communicate with other equipment in a core network, and/or that enables the base station to communicate with external networks, computers, databases, and the like for purposes of operations, administration, and maintenance of the base station or other equipment operably connected thereto.

Network device 1206 may include an RRM configuration module 1234. RRM configuration module 1234 may be implemented via hardware, software, or combinations thereof. For example, RRM configuration module 1234 may be implemented as a processor, circuit, and/or instructions 1226 stored in memory 1224 and executed by processor(s) 1222. In some examples, RRM configuration module 1234 may be integrated within processor(s) 1222 and/or the transceiver(s) 1228. For example, RRM configuration module 1234 may be implemented by a combination of software components (e.g., executed by a DSP or a general processor) and hardware components (e.g., logic gates and circuitry) within processor(s) 1222 or transceiver(s) 1228.

RRM configuration module 1234 may be used for various aspects of the present disclosure, for example, aspects of FIG. 1 and FIG. 5, or another other network functions, which may include receiving an RRM measurement.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method, performed by a user equipment (UE), for configuring radio resource management (RRM) relaxation in extended discontinuous reception (eDRX) mode, the method comprising:
determining whether an eDRX cycle is configured as being greater or less than 10.24 seconds;
determining whether the UE has met legacy RRM relaxation criteria for a relaxation scaling factor k; and
configuring RRM relaxation timing based on use of a paging transmission window (PTW) and the relaxation scaling factor k.

2. The method of claim 1, in which, in response to the eDRX cycle being less than or equal to 10.24 seconds and the PTW not being used in IDLE or Inactive mode, the method further comprises configuring the RRM relaxation timing to follow the eDRX cycle irrespective of the relaxation scaling factor k.

3. The method of claim 1, in which, in response to the eDRX cycle being less than or equal to 10.24 seconds and the PTW not being used in IDLE or Inactive mode, the method further comprises configuring the RRM relaxation timing by applying the relaxation scaling factor k on the eDRX cycle to implement RRM measurement based on the relaxation scaling factor k applied to the eDRX cycle.

4. The method of claim 1, in which, in response to the eDRX cycle being less than or equal to 10.24 seconds and the PTW not being used in IDLE or Inactive mode, the method further comprises configuring the RRM relaxation timing based on a comparison of the relaxation scaling factor to a ratio between the eDRX cycle and a legacy DRX cycle.

5. The method of claim 1, in which, in response to the eDRX cycle being less than or equal to 10.24 seconds and the PTW not being used in IDLE or Inactive mode, the method further comprises:
determining multiple relaxation criteria are met, the multiple relaxation criteria including the UE is not at cell edge and that it is stationary or low mobility; and
implementing RRM measurement based on the relaxation scaling factor k applied to the eDRX cycle.

6. The method of claim 1, in which, in response to the eDRX cycle being less than or equal to 10.24 seconds and the PTW not being used in IDLE or Inactive mode, the method further comprises receiving from a network an indication to relax RRM measurement based on the relaxation scaling factor k or an individual scaling factor k′ applied to the eDRX cycle.

7. The method of claim 1, in which, in response to the eDRX cycle being greater than 10.24 seconds and the PTW being used in IDLE mode, the method further comprises retaining PTW periodicity corresponding to the eDRX cycle for RRM measurement.

8. The method of claim 1, in which, in response to the eDRX cycle being greater than 10.24 seconds and the PTW being used in IDLE mode, the method further comprises determining whether a relaxed measurement period corresponding to the relaxation scaling factor k applied to a legacy measurement period is greater than a length of the PTW.

9. The method of claim 8, in which, in response to the relaxed measurement period being greater than the length of the PTW, the method further comprises configuring no relaxation within each PTW.

10. The method of claim 8, in which, in response to the relaxed measurement period being greater than the length of the PTW, the method further comprises employing another scaling factor k′ to perform RRM measurement relaxation, in which k′ is equal to the length of the PTW in units of a legacy DRX cycle divided by the legacy measurement period in units of the legacy DRX cycle.

11. The method of claim 8, in which, in response to the relaxed measurement period being greater than the length of the PTW, the method further comprises extending the PTW to the relaxation scaling factor k*the legacy measurement period.

12. The method of claim 1, in which, in response to the eDRX cycle being greater than 10.24 seconds and the PTW being used in IDLE mode, the method further comprises:
applying the relaxation scaling factor k to PTW periodicity corresponding to the eDRX cycle; and
implementing RRM measurement within each PTW based on one legacy DRX cycle as a measurement interval.

13. A non-transitory computer-readable storage medium of a user equipment (UE) for configuring radio resource management (RRM) relaxation in extended discontinuous reception (eDRX) mode, the computer-readable storage medium including instructions that when executed by the UE, cause the UE to:
determine whether an eDRX cycle is configured as being greater or less than 10.24 seconds;
determine whether the UE has met legacy RRM relaxation criteria for a relaxation scaling factor k; and
configure RRM relaxation timing based on use of a paging transmission window (PTW) and the relaxation scaling factor k.

14. The computer-readable storage medium of claim 13, in which, in response to the eDRX cycle being less than or equal to 10.24 seconds and the PTW not being used in IDLE or Inactive mode, the instructions further cause the UE to configure the RRM relaxation timing to follow the eDRX cycle irrespective of the relaxation scaling factor k.

15. The computer-readable storage medium of claim 13, in which, in response to the eDRX cycle being less than or equal to 10.24 seconds and the PTW not being used in IDLE or Inactive mode, the instructions further cause the UE to configure the RRM relaxation timing by applying the relaxation scaling factor k on the eDRX cycle to implement RRM measurement based on the relaxation scaling factor k applied to the eDRX cycle.

16. The computer-readable storage medium of claim 13, in which, in response to the eDRX cycle being less than or equal to 10.24 seconds and the PTW not being used in IDLE or Inactive mode, the instructions further cause the UE to configure the RRM relaxation timing based on a comparison of the relaxation scaling factor to a ratio between the eDRX cycle and a legacy DRX cycle.

17. The computer-readable storage medium of claim 13, in which, in response to the eDRX cycle being less than or equal to 10.24 seconds and the PTW not being used in IDLE or Inactive mode, the instructions further cause the UE to:
determine multiple relaxation criteria are met, the multiple relaxation criteria including the UE is not at cell edge and that it is stationary or low mobility; and
implement RRM measurement based on the relaxation scaling factor k applied to the eDRX cycle.

18. The computer-readable storage medium of claim 13, in which, in response to the eDRX cycle being less than or equal to 10.24 seconds and the PTW not being used in IDLE or Inactive mode, the instructions further cause the UE to receive from a network an indication to relax RRM measurement based on the relaxation scaling factor k or an individual scaling factor k′ applied to the eDRX cycle.

19. The computer-readable storage medium of claim 13, in which, in response to the eDRX cycle being greater than 10.24 seconds and the PTW being used in IDLE mode, the instructions further cause the UE to retain PTW periodicity corresponding to the eDRX cycle for RRM measurement.

20. The computer-readable storage medium of claim 13, in which, in response to the eDRX cycle being greater than 10.24 seconds and the PTW being used in IDLE mode, the instructions further cause the UE to determine whether a relaxed measurement period corresponding to the relaxation scaling factor k applied to a legacy measurement period is greater than a length of the PTW.

21-24. (canceled)
